(19) United States
(12) Patent Application Publication
(10) Pub. No.: US 2007/0003695 A1
(43) Pub. Date: Jan. 4, 2007

(54) Method of manufacturing a polymer memory device

(76) Inventors: Alexander Tregub, San Jose, CA (US); Michael J. Leeson, Portland, OR (US); Lee D. Rockford, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/174,129

(22) Filed: Jun. 30, 2005

(51) Int. Cl. B05D 3/12; B05D 3/02; B05D 7/00

(52) U.S. Cl. 427/240; 427/402; 427/374.2

(57) ABSTRACT

An embodiment of the invention is a method of manufacturing a polymer for a polymer ferroelectric memory. In particular, and among other features, the method of an embodiment alters the ferroelectric transition temperature, or Curie temperature, of the polymer by rapidly cooling the polymer from an elevated temperature. In particular, an embodiment increases the Curie temperature of the polymer, expanding the operating range of a polymer ferroelectric memory formed therewith.

### FIELD

Embodiments of the invention relate to ferroelectric memory, and more specifically to polymer ferroelectric memory and methods of manufacture thereof.

### BACKGROUND

Memory manufacturers are currently researching and developing the next generation of memory devices. One such development includes technology designed to replace current volatile and non-volatile memory technologies. Important elements of a successor include compactness, low price, low power operation, non-volatility, high density, fast read and write cycles, and long life.

Current memory technology is predicted to survive into 45 nanometer process generations. This survival is in part based on, for example, exotic storage dielectric materials, cobalt and nickel source and drain regions, copper and low dielectric constant materials for the interconnect levels, and high dielectric constant materials for transistor gates. However, there will thereafter exist a need for new memory materials and technology, particularly for non-volatile memory.

Ferroelectric memory is one such successor technology. A ferroelectric memory device combines the non-volatility of Flash memory with improved read and write speeds, high endurance, and low power consumption. Simply stated, ferroelectric memory devices rely on the use of ferroelectric materials that can be spontaneously polarized by an applied voltage or electric field and that maintain the polarization after the voltage or field has been removed. As such, a ferroelectric memory device can be programmed with a binary “1” or “0” depending on the orientation of the polarization. The state of the memory device can then be detected during a read cycle.

Two crystalline materials have emerged as promising films utilized in a ferroelectric memory scheme, namely lead zirconium titanate (“PZT”) and strontium bismuth tantalite (“SBT”). However, while the materials exhibit appropriate ferromagnetic properties, each is nevertheless expensive to integrate into an existing CMOS process.

More recent developments include the use of polymers that exhibit ferroelectric properties. The creation of polymer ferroelectric memory utilizes polymer chains with net dipole moments. Data is stored by changing the polarization of the polymer chain between metal lines that sandwich the layer comprised of the ferroelectric polymer chain. Further, the layers can be stacked (e.g., metal word line, ferroelectric polymer, metal bit line, ferroelectric polymer, metal word line, etc.) to improve memory element density. The polymer ferroelectric memory devices exhibit microsecond initial read speeds coupled with write speeds comparable to Flash.

### BRIEF DESCRIPTION OF THE DRAWINGS

FIG. 1: illustration of the chemical structure of a beta phase ferroelectric polyvinylidene fluoride (PVDF) polymer

FIG. 2: illustration of a top view of a ferroelectric polymer memory device

FIG. 3: illustration of a phase diagram for a polyvinylidene fluoride trifluoroethylene (PVDF-TrFE) copolymer

FIG. 4: illustration of a graph relating Curie temperature to PVDF-TrFE copolymer composition

FIG. 5: illustration of a differential scanning calorimetry output for three thermal treatments

FIG. 6: illustration of a differential scanning calorimetry output for three thermal treatments

FIG. 7: illustration of a graph relating Curie temperature to cooling depth

FIG. 8: illustration of process flow chart of an embodiment

FIG. 9: illustration of a process flow chart of another embodiment

### DETAILED DESCRIPTION

Embodiments of a method of manufacturing a polymer for a polymer ferroelectric memory are described. Reference will now be made in detail to a description of these embodiments as illustrated in the drawings. While the embodiments will be described in connection with these drawings, there is no intent to limit them to drawings disclosed herein. On the contrary, the intent is to cover all alternatives, modifications, and equivalents within the spirit and scope of the described embodiments as defined by the accompanying claims.

Simply stated, an embodiment of the invention is a method of manufacturing a polymer for a polymer ferroelectric memory. In particular, and among other features, the method of an embodiment alters the ferroelectric transition temperature, or Curie temperature, of the polymer by rapidly cooling the polymer from an elevated temperature. In particular, am embodiment increases the Curie temperature of the polymer, expanding the operating range of a polymer ferroelectric memory formed therewith.

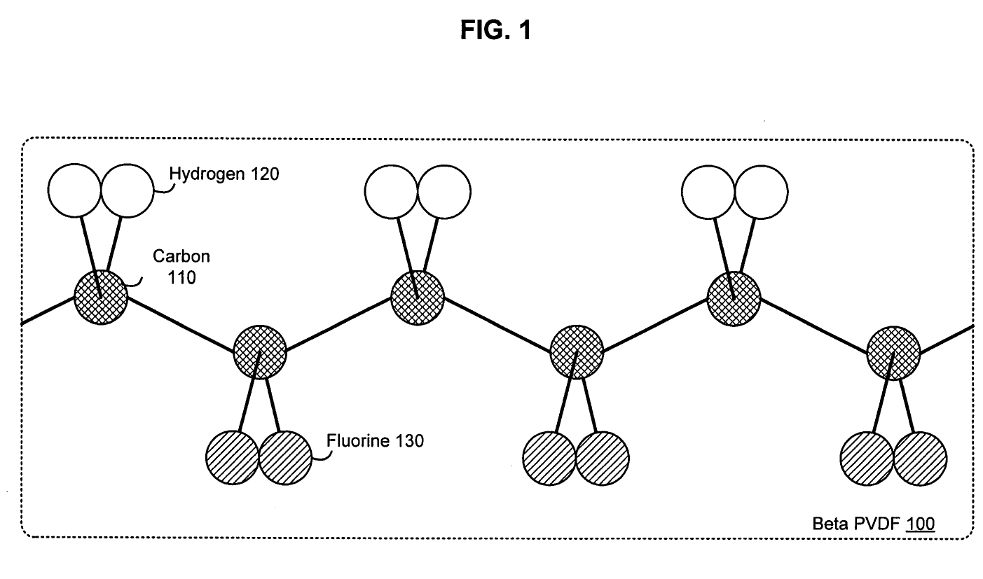

As noted, a large portion of the historical research in ferroelectric memory device technology has centered on select crystalline materials such as PZT and SBT. More current trends, however, include utilizing polymer chains that exhibit ferroelectric properties. Polyvinylidene Fluoride (“PVDF”) is a fluoropolymer with alternating CH₂ and CF₂ groups for which the relative electron densities between the hydrogen and fluorine atoms create a net ionic dipole moment. FIG. 1 illustrates the ferroelectric beta phase PVDF 100, including a chain of carbon 110 and alternating and opposing hydrogen 120 and fluorine 130 pairs. A particular PVDF copolymer is polyvinylidene fluoride trifluoroethylene (“PVDF-TrFE”). The addition of the trifluoroethylene C₂HF₃ (essentially substituting a hydrogen with a fluorine versus PVDF) in the chain reduces the overall theoretical ionic dipole moment of a ferroelectric PVDF beta phase chain, but increases the likelihood of forming the ferroelectric PVDF beta phase versus the paraelectric PVDF alpha phase during crystallization. The crystalline PVDF-TrFE polymer is ferroelectric in that it can be given a remnant polarization that can be switched in a sufficiently high electric field (i.e., a coercive field). The polarization can be used to store a binary “0” state and a binary “1” state of a memory device fabricated therewith based on the orientation of the polarization.

Memory elements utilizing polymer ferroelectric materials can be passive in the sense that there is no need for active components (e.g., a transistor coupled to a MOS capacitor in DRAM). Data is stored by changing the polarization of the polymer chain between metal electrode lines that sandwich the layer comprised of the ferroelectric polymer. The elements are driven externally by applying a voltage to the appropriate word and bit lines to read or write to a polymer ferroelectric memory cell. Configured as such, the read cycle is destructive and the memory cell must be rewritten.

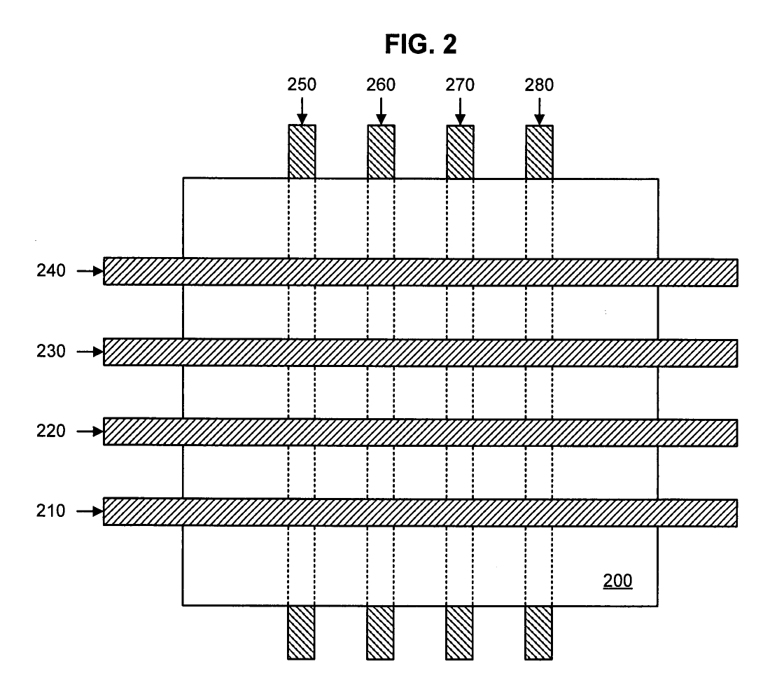

FIG. 2 illustrates a top view of a single layer polymer ferromagnetic memory device. Bit lines 250-280 and word lines 210-240 sandwich a layer of polymer ferroelectric material 200. When a voltage is applied across overlapping bit and word lines (e.g., bit line 250 and word line 240) a number of operational processes are possible. A relatively high voltage (e.g., ranging approximately between 5 and 15 volts), can create a coercive electric field sufficient to program a binary “1” state or a binary “0” state based on altering the orientation of the remanent polarization of the polymer ferroelectric material 200 sandwiched between the bit and word lines 250 and 240 respectively. A separate voltage can be applied, in conjunction with external detection circuitry not illustrated, to read the binary state of the memory cell. The sequence of applying alternating voltages to write and / or read the cells of the polymer ferroelectric material subjects the polymer contained within the memory cell to an AC bias. For example, one read or write cycle may expose the cell to a positive voltage difference between the word and bit line while another read or write cycle may expose the cell to a negative voltage difference between the word and bit line.

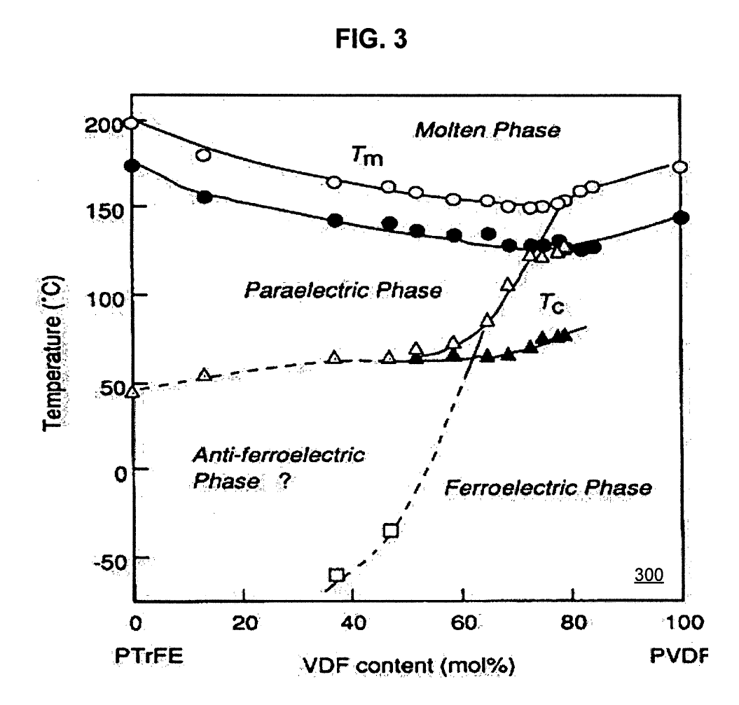

The performance of a ferroelectric polymer memory depends at least in part on the properties of the ferroelectric polymer material. For example, whether or not the polymer is ferroelectric depends at least in part on the polymer chemistry and temperature. FIG. 3, for example, illustrates a phase diagram 300 for a PVDF-TrFE copolymer. As noted, TrFE can be added to the PVDF to encourage the formation of the PVDF ferroelectric alpha phase. The phase diagram 300 indicates in what temperature range and PVDF:TrFE ratio the polymer is ferroelectric.

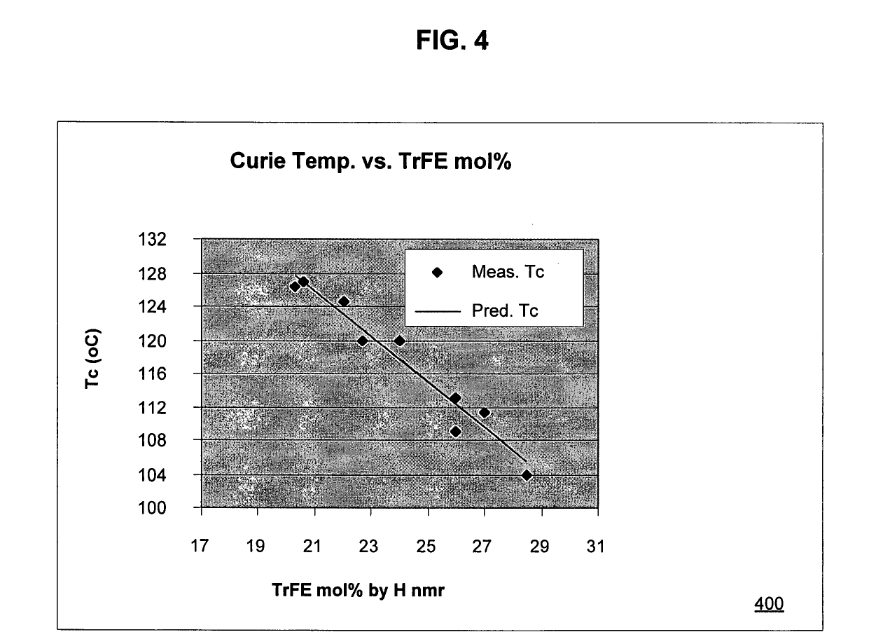

FIG. 3 also illustrates that altering the polymer structure (e.g., changing the ratio of the PVDF and TrFE polymers in polymer compound) alters the Curie temperature of the resulting PVDF-TrFE copolymer. However, for a given polymer ratio and/or structure, the Curie temperature is substantially constant. As polymer ratio also determines other important ferroelectric polymer properties such as solubility of the polymer in various solvents and transitions between various ferroelectric phases, altering the polymer ratio effectively to modify the Curie temperature may be impracticable. FIG. 4 is a graph 400 relating Curie temperature to mol percent TrFE composition in a PVDF-TrFE copolymer. Graph 400 indicates that the Curie temperature of the PVDF-TrFE copolymer increases as the mol percent TrFE composition decreases. The PVDF-TrFE copolymer of an embodiment is approximately 20 mol percent to 40 mol percent TrFE to balance increased Curie temperature with the copolymer's solubility in a solvent.

For a given copolymer ratio (e.g., a ratio selected based on its process compatibility) the method of an embodiment further alters the Curie temperature of the ferroelectric polymer by thermally treating the polymer. Thermal treatment of a polymer, such as cooling the polymer from an elevated temperature, changes, among other properties, the degree of crystallinity of a polymer film. A crystalline polymer is a polymer that exhibits a three-dimensional order on the level of atomic dimensions. The degree of crystallinity is the fractional amount of crystallinity in the polymer. The fractional amount of polymer crystallinity can be represented by a mass fraction or volume fraction and reflects the portion of the polymer that is crystalline phase versus amorphous phase. The change in polymer crystallinity in turn contributes to the Curie temperature of the polymer.

Changes in the degree of crystallinity of the polymer can be detected using common analytical techniques as x-ray diffraction (e.g., small- or wide-angle x-ray scattering), calorimetry (e.g., differential scanning calorimetry), density measurements, and infra-red spectroscopy (e.g., time and temperature dependent infra-red spectroscopy). The Curie temperature of the polymer can be measured using the same techniques or any technique available to more directly test the ferroelectric properties of a material. In particular, the Curie temperature may be determined using differential scanning calorimetry to identify the temperature of the first endothermic peak representing the ferroelectric transition of the polymer.

Curie temperature determines conditions at which ferroelectric polymer manifest its ferroelectric properties and, and can accordingly function to store information as a memory storage device. Increasing the Curie temperature of the ferroelectric polymer of a polymer ferroelectric memory device expands operating range of the memory device. A polymer ferroelectric memory would not function above the Curie temperatures of the ferroelectric polymer as the heightened thermal interactions within the polymer would negate its ferroelectric properties.

In embodiments, the polymer is exposed to thermal treatment that affects the polymer's crystallinity and related Curie temperature. Generally speaking, the embodiments involve rapidly cooling (at various rates that will be more fully discussed below) the polymer from an elevated temperature. Furthermore, the rapid cooling may have different cooling depths, or net temperature difference between the elevated temperature and cooled temperature. Different cooling depths may further contribute to the modification of the polymer's Curie temperature. Said alternatively, the increase in Curie temperature may be a function of the temperature to which temperature the polymer is cooled, the rate at which it is cooled, the temperature depth, or a combination thereof.

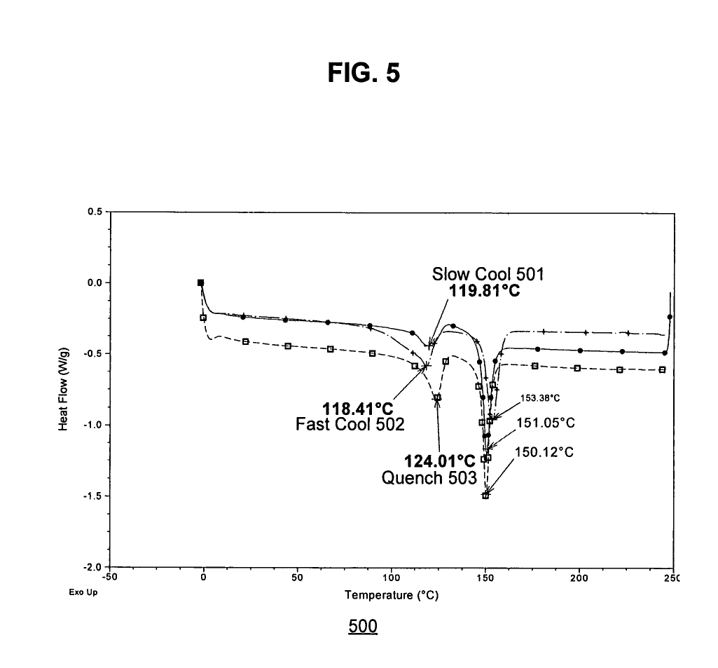

In an embodiment, the polymer is quenched from a temperature above its melting point (e.g., above approximately 150° C. as illustrated by the second endothermic peaks of the differential scanning calorimetry output 500 of FIG. 5 )to a temperature below its melting point. It is to be understood that the melting point may change depending on, for example, the PVDF:TrFE ratio of the PVDF-TrFE copolymer of an embodiment. Quenching is a process by which a material is exposed to a liquid (e.g., water, oil, and gases in liquid states) with a substantially large heat capacity to sink the heat of the material very rapidly. In an embodiment, the polymer is quenched from a temperature approximately above 150° C. by exposing the polymer to liquid nitrogen (i.e., a temperature below approximately −196° C., the boiling point of nitrogen). The rate at which the polymer is cooled is approximately 100° C. per second. In an embodiment, the polymer is cooled substantially instantaneously. In another embodiment, the polymer is rapidly cooled at a rate of approximately 50° C. per second to approximately 0° C. by exposing the polymer to ice and/or water containing ice. In an embodiment, the ice and/or ice water cool a cold plate. In a further embodiment, the polymer is cooled more slowly at a rate of approximately 20° C. per minute (i.e., approximately 0.33° C. per second) to approximately 30° C. The slow cool, for example, may represent exposure of the polymer to air that is approximately room temperature. It is to be understood that the cooling rate depends, in part, on the mass of the substrate including the polymer. In general, the heat required to change the temperature of a material is a function of the specific heat capacity of the material and the mass of the material. For a given material (e.g., a substrate including a ferroelectric polymer) the specific heat capacity is substantially constant so the amount of heat required to change the temperature of the material is a function of the mass of the material.

FIG. 5 illustrates a differential scanning calorimetry output 500 for a ferroelectric polymer subjected to the three different cooling thermal treatments introduced above. In an embodiment, the ferroelectric polymer is a PVDF-TrFE copolymer. The differential scanning calorimetry output 500 illustrates the Curie temperature at the first endothermic peak as the polymer samples (having been cooled according to an embodiment) is subsequently heated in the calorimeter. The slow cool 501 polymer exhibits a Curie temperature of approximately 118.4° C. The fast cool 502 polymer exhibits a Curie temperature of approximately 119.8° C. C. The quench 503 polymer exhibits a Curie temperature of approximately 124.0° C.

Though illustrated with particular Curie temperatures, it is to be understood that an embodiment pertains to relatively increasing the Curie temperature of a ferroelectric polymer by cooling thermal treatment independent or substantially independent of other process parameters. For the three thermal treatments described above, for example, the Curie temperature of the polymer has been increased by approximately 5.6° C. based substantially on cooling process alone.

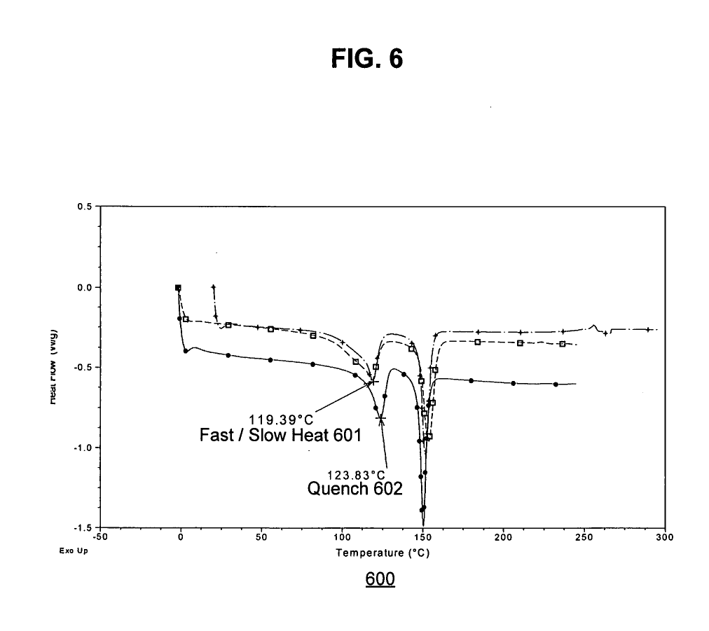

FIG. 6 illustrates an additional differential scanning calorimetry output 600 for a ferroelectric polymer subjected to the three different thermal treatments. The particular comparison is between heating rate and cooling rate. As illustrated, fast heating (e.g., at approximately 50° C. per minute) and slow heating (e.g., approximately 5° C. per minute), collectively labeled fast/slow heat 601 exhibits a Curie temperature of approximately 119.4° C. while the quench 602 polymer exhibits a-Curie temperature of approximately 123.8° C. More generally, as explained with reference to FIG. 5, the cooling rate affects the Curie temperature while the heating rate does not affect the Curie temperature.

An embodiment further alters the cooling depth of the polymer to increase its Curie temperature. Cooling depth as used herein refers to the lowest cooling temperature achieved by the polymer. Accordingly, a further embodiment controls both the cooling rate and cooling depth to which the polymer is exposed to increase the Curie temperature of the polymer.

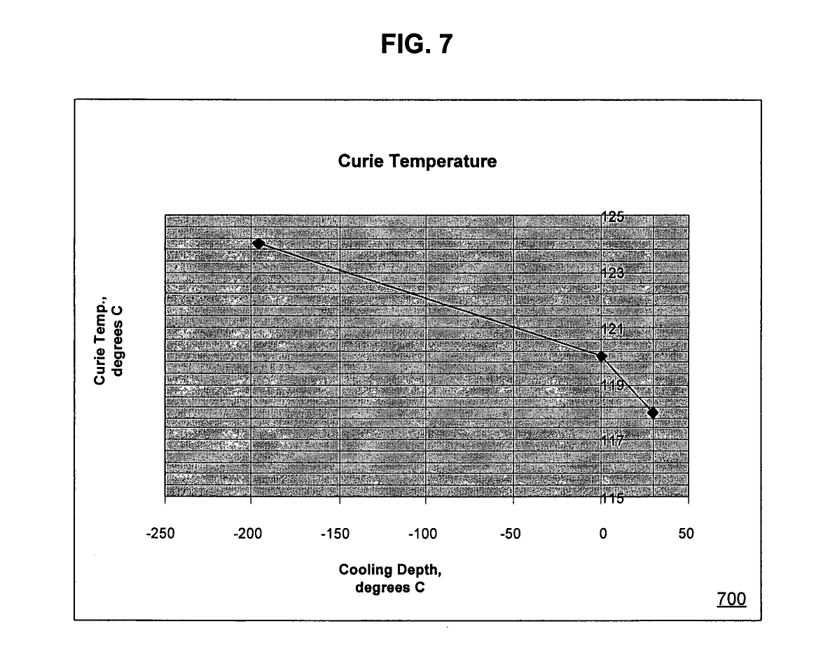

FIG. 7 illustrates in graph 700 more specific details of cooling depth versus Curie temperature for three polymer samples exposed to three different thermal treatments (e.g., slow, fast, and quench as described above). As illustrated, the Curie temperature of the polymer is related to the cooling depth in that the Curie temperature of the polymer increases as the cooling depth decreases.

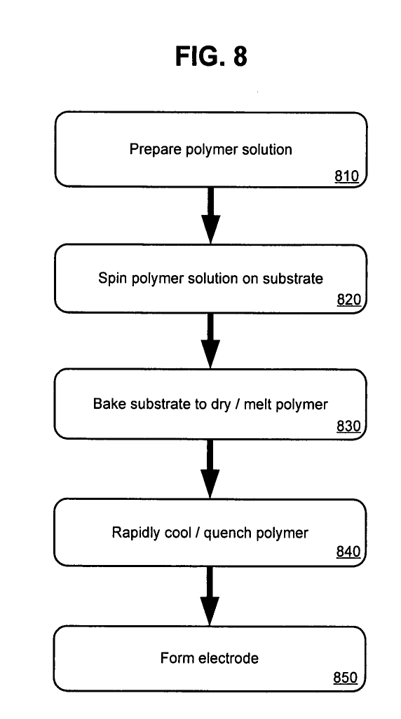

FIG. 8 illustrates a process flow of an embodiment. A polymer solution is prepared, 810, by dissolving the polymer material in a solvent. In an embodiment the polymer is PVDF. In a further embodiment, the polymer is a PVDF-TrFE copolymer, and the solvent is diethyl carbonate, propylene glycol monomethyl ether acetate (PGMEA), ethyl lactate, or other organic solvent. The polymer solution is thereafter spun onto a substrate, 820. The substrate may be any substrate or process layer on which the polymer solution may be deposited. In an embodiment, the substrate includes an electrode or electrodes (e.g., it lines 250-280 of FIG. 2). Thereafter, the substrate including the polymer is baked to dry the polymer of the solvent and to melt the polymer, 830. In an embodiment, the polymer is heated to above approximately 150° C. The melted polymer is then exposed to the thermal treatment of embodiments as is rapidly cooled or quenched, 840, to increase its Curie temperature. Thereafter, electrodes may be formed, 850, (e.g., word lines 210-240 of FIG. 2) to complete a polymer ferroelectric memory device.

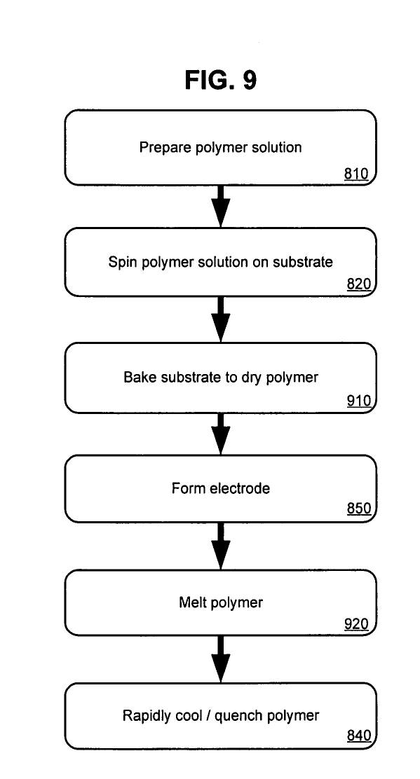

FIG. 9 illustrates a process flow of another embodiment. As illustrated, the electrodes may be formed, 850, (e.g., word lines 210-240 of FIG. 2) before the polymer is exposed to the thermal treatments of embodiments. For example, after the polymer solution is spun onto a substrate, 820, it is thereafter baked to dry the polymer, 910 (e.g., drive out any solvent). An electrode is formed, 850, followed by melting the polymer, 920. In an embodiment, the polymer is heated to above approximately 150° C. to melt the polymer, 920. Once the polymer is melted, 920, it is rapidly cooled or quenched, 840, to increase its Curie temperature.

One skilled in the art will recognize the elegance of the disclosed embodiment in that it improves the ability with which a ferroelectric polymer can be used for a polymer ferroelectric memory device in that the resulting memory device will have an increased operating temperature range as a result of the increased Curie temperature of the constituent ferroelectric polymer.

What is claimed is:

1. A method comprising:
heating a ferroelectric polymer above its melting point; and
quenching the ferroelectric polymer.

2. The method of claim 1, quenching the ferroelectric polymer further comprising:
decreasing the temperature of the ferroelectric polymer at a rate of approximately 100° C. per second.

3. The method of claim 1, quenching the ferroelectric polymer further comprising:
exposing the ferroelectric polymer to liquid nitrogen.

4. The method of claim 3 further comprising:
decreasing the temperature of the ferroelectric polymer to the temperature of the liquid nitrogen substantially instantaneously.

5. The method of claim 1, the ferroelectric polymer further comprising polyvinylidene fluoride.

6. The method of claim 1, the ferroelectric polymer further comprising a polyvinylidene fluoride trifluoroethylene copolymer.

7. The method of claim 6, the polyvinylidene fluoride trifluoroethylene copolymer further comprising approximately between 20 mol percent and 40 mol percent trifluoroethylene.

8. The method of claim 1 further comprising:
increasing the Curie temperature of the ferroelectric polymer.

9. A method comprising:
heating a ferroelectric polymer above its melting point; and
rapidly cooling the ferroelectric polymer at a rate of approximately 50° C. per second.

10. The method of claim 9, rapidly cooling the ferroelectric polymer at a rate of approximately 50° C. per second further comprising:
exposing the ferroelectric polymer to ice or ice water.

11. The method of claim 9, the ferroelectric polymer further comprising polyvinylidene fluoride.

12. The method of claim 9, the ferroelectric polymer further comprising a polyvinylidene fluoride trifluoroethylene copolymer.

13. The method of claim 12, the polyvinylidene fluoride trifluoroethylene copolymer further comprising approximately between 20 mol percent and 40 mol percent trifluoroethylene.

14. A method comprising:
spin depositing a ferroelectric polymer solution on a substrate including an electrode;
heating the ferroelectric polymer solution to remove a solvent;
rapidly cooling the ferroelectric polymer.

15. The method of claim 14 further comprising:
forming another electrode on the ferroelectric polymer

16. The method of claim 15, heating the ferroelectric polymer further comprising:
melting the ferroelectric polymer.

17. The method of claim 16, rapidly cooling the ferroelectric polymer further comprising: quenching the ferroelectric polymer by exposing the ferroelectric polymer to liquid nitrogen.

18. The method of claim 17 wherein melting the ferroelectric polymer and quenching the ferroelectric polymer precede forming another electrode on the ferroelectric polymer.

19. The method of claim 17 wherein forming another electrode precedes melting the ferroelectric polymer and quenching the ferroelectric polymer.
